(19) United States
(12) Patent Application Publication
(10) Pub. No.: US 2026/0057328 A1
(43) Pub. Date: Feb. 26, 2026

(54) COMMON RISK SEGMENTS, FRACTURE RANKING, AND TEXTURE SIMILARITY FOR COMPLETION DECISIONS

(71) Applicant: Schlumberger Technology Corporation, Sugar Land, TX (US)

(72) Inventors: Mohammed Hany Nassar, Doha (QA); Redha Hasan Ibrahim Al Lawati, Doha (QA); John Adam Donald, Dubai (AE); Rishav Goswami, Doha (QA); Aly Morad, Doha (QA); Laura Pontarelli, Doha (QA); Daniel Nketah, Doha (QA)

(21) Appl. No.: 19/305,104

(22) Filed: Aug. 20, 2025

Related U.S. Application Data
(60) Provisional application No. 63/686,033, filed on Aug. 22, 2024.

(51) Int. Cl. G06Q 10/0637; E21B 47/002; E21B 49/00; G06Q 10/0635; G06Q 50/06

(52) U.S. Cl. CPC G06Q 10/0637; E21B 47/0025; E21B 49/006; G06Q 10/0635; G06Q 50/06

(57) ABSTRACT

The present disclosure provides techniques and apparatus for performing well completion design and evaluation. An example technique includes obtaining a plurality of measurement datasets associated with subsurface features of a wellbore. A distance data structure including a respective pairwise distance metric for at least one pair of subsurface features of the wellbore is generated. Fracture pathways in the wellbore are determined, based on the distance data structure. A respective texture type corresponding to each segment of at least one interval of the wellbore is determined. A risk metric is generated for each segment indicating a likelihood that completing the segment will establish a communication with at least one of the one or more fractures, the one or more faults, or the fluid contact boundaries in the wellbore. A completion recommendation is output, based at least in part on the risk metrics.

### CROSS-REFERENCE TO RELATED APPLICATION

This application claims benefit of and priority to U.S. Provisional Patent Application Ser. No. 63/686,033, filed Aug. 22, 2024, which is hereby incorporated by reference herein in its entirety for all applicable purposes.

### BACKGROUND

### Field of the Disclosure

The present disclosure generally relates to well placement and evaluation, and more specifically, to techniques and systems for well completion planning in subsurface hydrocarbon reservoirs.

### Description of Related Art

A reservoir is generally a subsurface formation that can be characterized at least in part by the reservoir's porosity and fluid permeability. For example, a reservoir may be part of a basin such as a sedimentary basin. A basin can be a depression (e.g., caused by plate tectonic activity, subsidence, etc.) in which sediments accumulate. For instance, in cases where hydrocarbon source rocks occur in combination with appropriate depth and duration of burial, a petroleum system may develop within a basin, which may form a reservoir that includes hydrocarbon fluids (e.g., oil, gas, etc.).

Well completions are a critical phase in the development of hydrocarbon reservoirs. Conventionally, completion decisions have relied on manual interpretation of disparate data sources, such as borehole images, resistivity logs, and seismic maps. This process typically involves multiple subject matter experts working independently to assess individual datasets, including, for example, conductive and resistive fracture indicators, sonic or acoustic impedance contrasts, and geologic boundaries inferred from seismic data. However, this process is significantly labor intensive and often results in suboptimal completion decisions.

### SUMMARY

One embodiment of the present disclosure described herein is a method. The method includes obtaining a plurality of measurement datasets associated with subsurface features of a wellbore. The plurality of measurement datasets includes (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore. The method also includes generating a distance data structure comprising a respective pairwise distance metric for at least one pair of subsurface features of the wellbore. The method also includes determining one or more fracture pathways in the wellbore, based at least in part on the distance data structure. The method also includes determining, for at least one interval of the wellbore, a respective texture type corresponding to each segment of at least one interval, based at least in part on the second measurement dataset. The method also includes generating, for each segment, a risk metric indicating a likelihood that completing the segment will establish a communication with at least one of the one or more fractures, the one or more faults, or the fluid contact boundaries in the wellbore. The method further includes outputting a completion recommendation, based at least in part on the risk metrics.

Another embodiment of the present disclosure described herein is a computing system. The computing system includes one or more memories collectively storing instructions and one or more processors communicatively coupled to the one or more memories. The one or more processors are collectively configured to execute the instructions to cause the computing system to: obtain a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore; generate a distance data structure comprising a respective pairwise distance metric for at least one pair of subsurface features of the wellbore; determine one or more fracture pathways in the wellbore, based at least in part on the distance data structure; determine, for at least one interval of the wellbore, a respective texture type corresponding to each segment of the at least one interval, based at least in part on the second measurement dataset; generate, for each segment, a risk metric indicating a likelihood that completing the segment will establish a communication with at least one of the one or more fractures, the one or more faults, or the fluid contact boundaries in the wellbore; and output a completion recommendation, based at least in part on the risk metrics.

Another embodiment of the present disclosure described herein is a non-transitory computer-readable storage medium. The non-transitory computer-readable storage medium includes computer-executable code, which when executed by one or more processors of a computing system perform an operation. The operation includes obtaining a plurality of measurement datasets associated with subsurface features of a wellbore. The plurality of measurement datasets includes (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore. The operation also includes generating a distance data structure comprising a respective pairwise distance metric for at least one pair of subsurface features of the wellbore. The operation also includes determining one or more fracture pathways in the wellbore, based at least in part on the distance data structure. The operation also includes determining, for at least one interval of the wellbore, a respective texture type corresponding to each segment of the at least one interval, based at least in part on the second measurement dataset. The operation also includes generating, for each segment, a risk metric indicating a likelihood that completing the segment will establish a communication with at least one of the one or more fractures, the one or more faults, or the fluid contact boundaries in the wellbore. The operation further includes outputting a completion recommendation, based at least in part on the risk metrics.

The following description and the appended figures set forth certain features for purposes of illustration.

### BRIEF DESCRIPTION OF DRAWINGS

Various embodiments in accordance with the present disclosure will be described with reference to the drawings, where like designations denote like elements. Note that the appended drawings illustrate typical embodiments and are therefore not to be considered limiting; other equally effective embodiments are contemplated.

FIG. 1 illustrates an example computing system, according to certain embodiments.

FIGS. 2A-2D illustrate different schematic views of an oilfield, according to certain embodiments.

FIG. 3 illustrates a schematic view of another oilfield, according to certain embodiments.

FIG. 4 illustrates an example oilfield for performing production operations, according to certain embodiments.

FIG. 5 illustrates a workflow for evaluating a wellbore based on three-dimensional (3D) resistivity mapping, according to certain embodiments.

FIG. 6 illustrates a workflow for well completion, according to certain embodiments.

FIG. 7 illustrates a 3D view of a well trajectory, according to certain embodiments.

FIG. 8 illustrates another 3D view of a well trajectory, according to certain embodiments.

FIG. 9 illustrates an example map view of a well trajectory, according to certain embodiments.

FIG. 10 illustrates a two-dimensional (2D) cross-section with heterogeneous source information for a wellbore, according to certain embodiments.

FIG. 11 illustrates an example risk flag scheme, according to certain embodiments.

FIG. 12 illustrates an example risk flag for a selected interval along a wellbore, according to certain embodiments.

FIG. 13 illustrates a graph showing a comparison of reservoir thicknesses for multiple texture types before and after isolation of high risk intervals, according to certain embodiments.

FIG. 14 a flow diagram depicting an example operations for well completion and evaluation, according to certain embodiments.

### DETAILED DESCRIPTION

In the development and production of hydrocarbon reservoirs, well completions play a critical role in determining the long term productivity and efficiency of a well. Completion decisions often have to balance the goal of maximizing hydrocarbon recovery with the goals of minimizing water production and avoiding premature breakthrough from unwanted fluid zones. In certain wells (e.g., high angle and horizontal wells), however, the complexity of subsurface environments presents a significant challenge to identifying optimal intervals for completions. For these wells, operators often have to interpret multiple sources of downhole data (acquired using different tools) and integrate this data quickly to make informed decisions in the narrow time window between drilling and completion.

Conventional approaches to well evaluation and completion planning rely on manual integration of data from diverse sources, including borehole images, deep resistivity measurements, sonic imaging, and seismic interpretation. This manual process involves collaboration among multiple subject matter experts and is time consuming, error prone, and difficult to scale. Moreover, using a manual process can make the visualization and interpretation of three-dimensional (3D) measurement data significantly challenging and lead to delayed completion decisions as well as suboptimal outcomes due to incomplete analysis. Thus, while advancements in measurement tools have enabled acquisition of 3D resistivity data, 3D sonic imaging, and high-resolution borehole images, conventional well evaluation approaches have limited the ability to fully leverage these tools for completion design. Accordingly, it may be desirable to provide improved techniques for well completion evaluation.

The disclosure provides techniques, methods, systems, apparatus, and computer-readable media for well completion planning and design in subsurface hydrocarbon reservoirs. In certain embodiments described herein, an automated framework is provided for integrating and interpreting multiple sources of subsurface measurement data, including borehole images, 3D resistivity mapping, 3D sonic imaging, and seismic data, as illustrative examples, to identify fluid flow pathways, assess completion risks, optimize completion design in high angle or horizontal wells, or any combination thereof.

The techniques, methods, systems, apparatus, and computer readable media for well completion planning and design in subsurface hydrocarbon reservoirs may provide various technical advantages. For example, the integrated framework described herein may enable the determination of pathways between fractures intersecting the wellbore and fractures away from the wellbore, identification of pathways for water entry points, quantification of common risks associated with different intervals, isolation of zones in communication with confirmed water contacts, assessment of risk tolerance and threshold sensitivity, selection of optimal completion design based on reservoir simulation, or any combination thereof.

The following description includes embodiments of the best mode presently contemplated for practicing the described implementations. This description is not to be taken in a limiting sense, but rather is made merely for the purpose of describing the general principles of the implementations. The scope of the described implementations should be ascertained with reference to the issued claims.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

As used herein, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Example Computing System for Well Evaluation

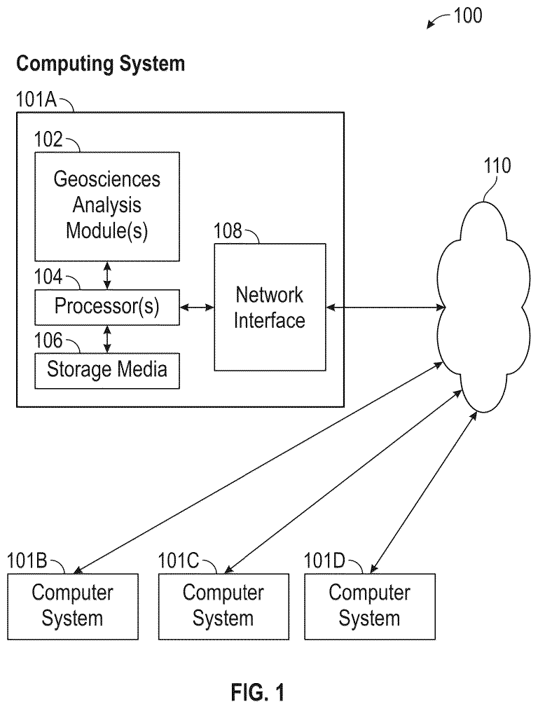

FIG. 1 illustrates an example computing system 100, according to certain embodiments. The computing system 100 can be an individual computer system 101A or an arrangement of distributed computer systems. The computer system 101A includes one or more geosciences analysis modules 102 that are configured to perform various tasks according to certain embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that the data network 110 may be a private network, the data network 110 may use portions of public networks, the data network 110 may include remote storage and/or applications processing capabilities (e.g., cloud computing), or any combination thereof.

The processor 104 can include a microprocessor, microcontroller, processor module or subsystem, programmable integrated circuit, programmable gate array, or another control or computing device. The storage media 106 can be implemented as one or more computer-readable or machine-readable storage media. Note that, while in the example embodiment of FIG. 1, storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic random access memories (DRAMs) or static random access memories (SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), Blue-rays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both hardware and software, including one or more signal processing and/or application specific integrated circuits.

It should also be appreciated that while no user input/output peripherals are illustrated with respect to computer systems 101A, 101B, 101C, and 101D, certain embodiments of computing system 100 include computer systems with keyboards, mice, touch screens, displays, etc. Some computer systems in use in computing system 100 may be desktop workstations, laptops, tablet computers, smartphones, server computers, etc. Further, the steps in the processing methods described herein may be implemented by running one or more functional modules in information processing apparatus such as general purpose processors or application specific chips, such as application specific integrated circuits (ASICs), field programmable gate arrays (FPGAs), programmable logic devices (PLDs), or other appropriate devices.

### Example Reservoir Environments

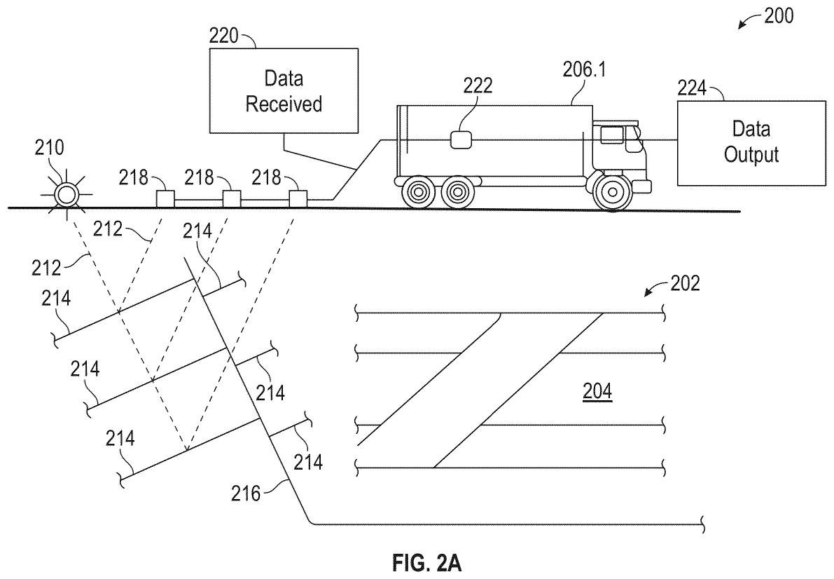

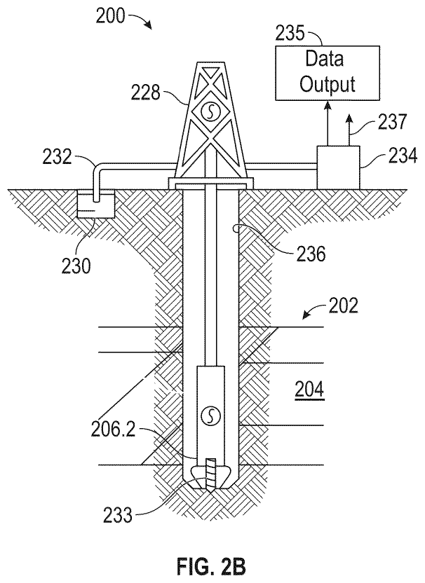

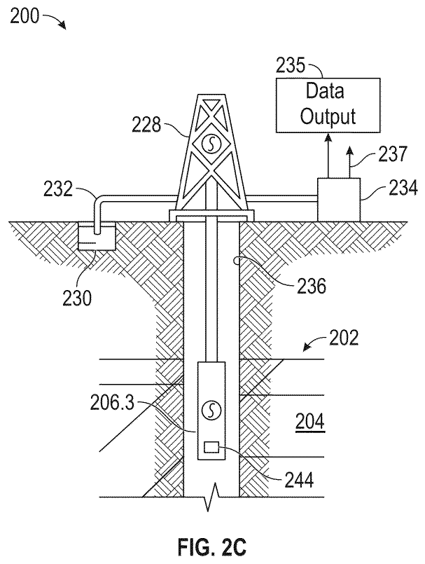

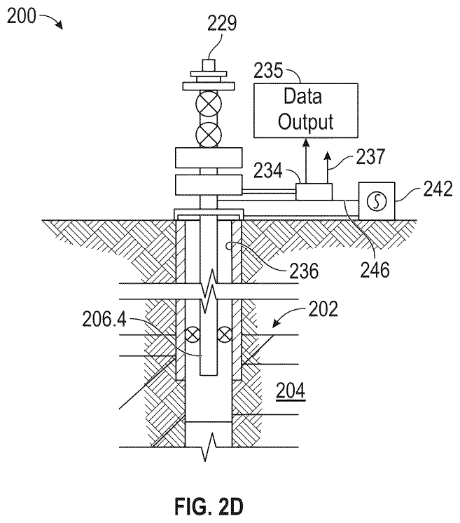

FIGS. 2A-2D illustrate schematic views of an oilfield 200 having subterranean formation 202 including reservoir 204 therein, in accordance with certain embodiments of the present disclosure. One or more of the components illustrated in FIG. 1 (including, for example, computing system 100 and/or one or more components thereof) may be implemented as part of the oilfield 200.

FIG. 2A illustrates a survey operation being performed by a survey tool, such as seismic truck 206.1, to measure properties of the subterranean formation 202. The survey operation is a seismic survey operation for producing sound vibrations. In FIG. 2A, one such sound vibration, e.g., sound vibration 212 generated by source 210, reflects off horizons 214 in earth formation 216. A set of sound vibrations is received by sensors, such as geophone-receivers 218, situated on the earth's surface. The data received 220 is provided as input data to a computer 222 of a seismic truck 206.1, and responsive to the input data, computer 222 generates seismic data output 224. This seismic data output 224 may be stored, transmitted or further processed as desired, for example, by data reduction.

FIG. 2B illustrates a drilling operation being performed by drilling tools 206.2 suspended by rig 228 and advanced into subterranean formations 202 to from wellbore 236. Mud pit 230 is used to draw drilling mud into the drilling tools 206.2 via flow line 232 for circulating drilling mud down through the drilling tools 206.2, then up wellbore 236 and back to the surface. The drilling mud is typically filtered and returned to the mud pit 230. A circulating system may be used for storing, controlling, or filtering the flowing drilling mud. The drilling tools 206.2 are advanced into subterranean formations 202 to reach reservoir 204. Each well may target one or more reservoirs. The drilling tools are adapted for measuring downhole properties using logging while drilling tools. The logging while drilling tools 206.2 may also be adapted for taking core samples 233 as shown.

Computer facilities may be positioned at various locations about the oilfield 200 (e.g., the surface unit 234) and/or at remote locations. Surface unit 234 may be used to communicate with the drilling tools 206.2 and/or offsite operations, as well as with other surface or downhole sensors. Surface unit 234 is capable of communicating with the drilling tools 206.2 to send commands to the drilling tools 206.2, and to receive data therefrom. Surface unit 234 may also collect data generated during the drilling operation and produce data output 235, which may then be stored or transmitted.

Sensors (S), such as gauges, may be positioned about oilfield 200 to collect data relating to various oilfield operations as described previously. As shown, sensor (S) is positioned in one or more locations in the drilling tools 206.2 and/or at rig 228 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 206.2 may include a bottom hole assembly (BHA)(not shown), generally referenced, near the drill bit (e.g., within several drill collar lengths from the drill bit). The bottom hole assembly includes capabilities for measuring, processing, and storing information, as well as communicating with surface unit 234. The bottom hole assembly further includes drill collars for performing various other measurement functions.

The bottom hole assembly may include a communication subassembly that communicates with surface unit 234. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan generally sets forth equipment, pressures, trajectories and/or other parameters that define the drilling process for the wellsite. The drilling operation may then be performed according to the drilling plan. However, as information is gathered, the drilling operation may have to deviate from the drilling plan. Additionally, as drilling or other operations are performed, the subsurface conditions may change. The earth model may also be adjusted as new information is collected.

The data gathered by sensors (S) may be collected by surface unit 234 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 234 may include transceiver 237 to allow communications between surface unit 234 and various portions of the oilfield 200 or other locations. Surface unit 234 may also be provided with or functionally connected to one or more controllers (not shown) for actuating mechanisms at oilfield 200. Surface unit 234 may then send command signals to oilfield 200 in response to data received. Surface unit 234 may receive commands via transceiver 237 or may itself execute commands to the controller. A processor may be provided to analyze the data (locally or remotely), make the decisions and/or actuate the controller. In this manner, oilfield 200 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 2C illustrates a wireline operation being performed by wireline tool 206.3 suspended by rig 228 and into wellbore 236 of FIG. 2C. Wireline tool 206.3 is adapted for deployment into wellbore 236 for generating well logs, performing downhole tests and/or collecting samples. Wireline tool 206.3 may be used to provide another method and apparatus for performing a seismic survey operation. Wireline tool 206.3 may, for example, have an explosive, radioactive, electrical, or acoustic energy source 244 that sends and/or receives electrical signals to surrounding subterranean formations 202 and fluids therein.

Wireline tool 206.3 may be operatively connected to, for example, geophones 218 and a computer 222 of a seismic truck 206.1 of FIG. 2A. Wireline tool 206.3 may also provide data to surface unit 234. Surface unit 234 may collect data generated during the wireline operation and may produce data output 235 that may be stored or transmitted. Wireline tool 206.3 may be positioned at various depths in the wellbore 236 to provide a survey or other information relating to the subterranean formation 202.

Sensors (S), such as gauges, may be positioned about oilfield 200 to collect data relating to various field operations as described previously. As shown, sensor S is positioned in wireline tool 206.3 to measure downhole parameters which relate to, for example porosity, permeability, fluid composition and/or other parameters of the field operation.

FIG. 2D illustrates a production operation being performed by production tool 206.4 deployed from a production unit or Christmas tree 229 and into completed wellbore 236 for drawing fluid from the downhole reservoirs into surface facilities 242. The fluid flows from reservoir 204 through perforations in the casing (not shown) and into production tool 206.4 in wellbore 236 and to surface facilities 242 via gathering network 246.

Sensors (S), such as gauges, may be positioned about oilfield 200 to collect data relating to various field operations as described previously. As shown, the sensor (S) may be positioned in production tool 206.4 or associated equipment, such as Christmas tree 229, gathering network 246, surface facility 242, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 2A-2D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 2A-2D are intended to provide a brief description of an example of a field usable with oilfield application frameworks. Part of, or the entirety of, oilfield 200 may be on land, water, and/or sea. Also, while a single field measured at a single location is depicted, oilfield applications may be utilized with any combination of one or more oilfields, one or more processing facilities and one or more wellsites.

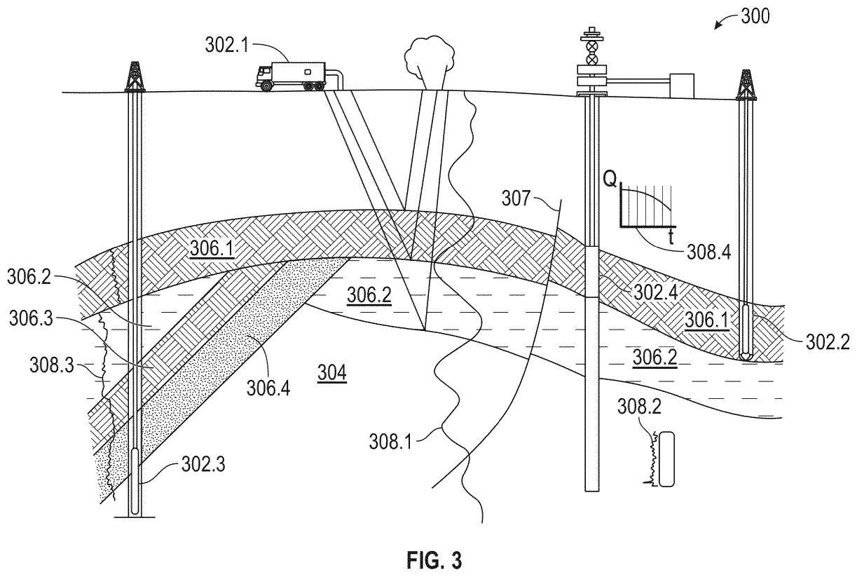

FIG. 3 illustrates a schematic view, partially in cross section, of oilfield 300 having data acquisition tools 302.1, 302.2, 302.3 and 302.4 positioned at various locations along oilfield 300 for collecting data of subterranean formation 304, in accordance with certain embodiments described herein. Data acquisition tools 302.1-302.4 may be the same as data acquisition tools 206.1-206.4 of FIGS. 2A-2D, respectively, or others not depicted. As shown, data acquisition tools 302.1-302.4 generate data plots or measurements 308.1-308.4, respectively. These data plots are depicted along oilfield 300 to demonstrate the data generated by the various operations.

Data plots 308.1-308.3 are examples of static data plots that may be generated by data acquisition tools 302.1-302.3, respectively; however, it should be understood that data plots 308.1-308.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 308.1 is a seismic two-way response over a period of time. Static plot 308.2 is core sample data measured from a core sample of the subterranean formation 304. The core sample may be used to provide data, such as a graph of the density, porosity, permeability, or some other physical property of the core sample over the length of the core. Tests for density and viscosity may be performed on the fluids in the core at varying pressures and temperatures. Static data plot 308.3 is a logging trace that typically provides a resistivity or other measurement of the formation at various depths.

A production decline curve or graph 308.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 304 has a plurality of geological formations 306.1-306.4. As shown, this structure has several formations or layers, including a shale layer 306.1, a carbonate layer 306.2, a shale layer 306.3 and a sand layer 306.4. A fault 307 extends through the shale layer 306.1 and the carbonate layer 306.2. The static data acquisition tools are adapted to take measurements and detect characteristics of the formations.

While a specific subterranean formation with specific geological structures is depicted, it will be appreciated that oilfield 300 may include a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 300, it will be appreciated that one or more types of measurements may be taken at one or more locations across one or more fields or other locations for comparison and/or analysis.

The data collected from various sources, such as the data acquisition tools of FIG. 3, may then be processed and/or evaluated. Seismic data displayed in static data plot 308.1 from data acquisition tool 302.1 may be used by a geophysicist to determine characteristics of the subterranean formations and features. The core data shown in static plot 308.2 and/or log data from well log 308.3 may be used by a geologist to determine various characteristics of the subterranean formation. The production data from graph 308.4 may be used by the reservoir engineer to determine fluid flow reservoir characteristics. The data analyzed by the geologist, geophysicist and the reservoir engineer may be analyzed using modeling techniques.

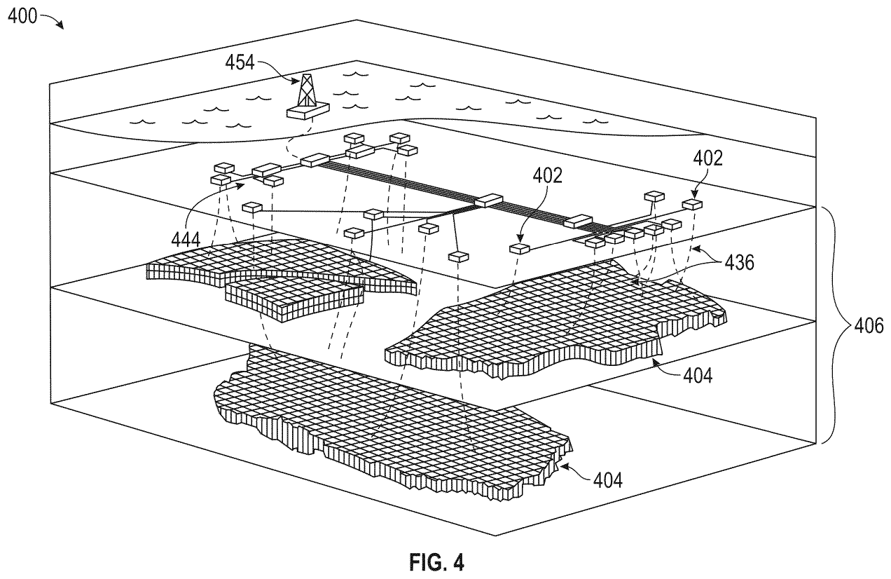

FIG. 4 illustrates an oilfield 400 for performing production operations, according to certain embodiments. The production operations may be performed in accordance with implementations of various technologies and techniques described herein. As shown, the oilfield has a plurality of wellsites 402 operatively connected to central processing facility 454. The oilfield configuration of FIG. 4 is not intended to limit the scope of the oilfield application system. Part, or all, of the oilfield may be on land and/or sea. Also, while a single oilfield 400 with a single processing facility 454 and a plurality of wellsites 402 is depicted, any combination of one or more oilfields, one or more processing facilities and one or more wellsites may be present.

Each wellsite 402 has equipment that forms wellbore 436 into the earth. The wellbores 436 extend through subterranean formations 406 including reservoirs 404. These reservoirs 404 contain fluids, such as hydrocarbons. The wellsites 402 draw fluid from the reservoirs 404 and pass them to the processing facilities 454 via surface networks 444. The surface networks 444 have tubing and control mechanisms for controlling the flow of fluids from the wellsites 402 to the central processing facility 454.

Attention is now directed to methods, techniques, and workflows for planning, forecasting, and/or optimizing production related systems (e.g., model selections, reservoir maps, wells, etc.) in accordance with certain embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

### Introduction to Marine Source Technology

Seismic acquisitions in marine environments are typically carried out using sensors mounted either along cables towed by one or more vessels, or in nodes deployed at designed positions at the bottom of the sea.

The signal to be measured is generated as an acoustic wave by tools called seismic sources, also towed by vessels. The source generates acoustic waves that propagate in the water and in the subsurface, to then reach the receivers where the wavefields are measured.

In some cases, seismic sources in water are realized as arrays of air-guns. A seismic vessel can carry one or more arrays of air-guns, and generally dual or triple source vessels are quite a common choice in recent years. An array of air-guns is typically made of 2 or 3 subarrays of about 6 or more air-guns each. Traditionally, the arrays are deployed at the same depth, but source design with arrays at different depths can also be used (i.e. Delta Sources). Seismic sources with different number of sub-arrays are also possible, depending on design choices. Also, subarrays with a different number of guns are possible. The air-guns in source arrays are not set to be identical, and each of them can be described by a different volume of air, which is released in the water once the door is opened. Depending on the distribution of the volume of air in the array, and the timing at which each gun is shot, the shape of the seismic wavefront that is generated by the air-gun scan varies, and so its radiation pattern. The resulting seismic wave generated by the shooting of the whole array defines the source signature of a seismic wavefield.

More recently, different sources technologies have been introduced in the industry, including low-frequency sources and marine vibrators, as illustrative examples. These sources generate seismic wavefields with different properties with respect to traditional arrays, providing improved signal-to-noise ratio in targeted portions of the bandwidth of the seismic signals.

Generally, air-gun sources generate broadband signals in a bandwidth that can go from 1.5 hertz (Hz) to above 100 Hz, and sometimes above 200 Hz. In some cases, the energy below 3 to 5 Hz is relatively weak compared to other portions of the bandwidth.

However, there are many applications and technologies such as full waveform inversion (FWI) that utilize high quality ultra-low frequency signals in order to generate accurate models of the subsurface. Hence, alternative sources may be used to generate signals at these frequencies with an improved signal-to-noise ratio (SNR) with respect to the signals generated by arrays of air-guns. The so called “low-frequency” sources and the marine vibrators can generate signals with favorable SNR up to very low frequencies (1.2 Hz).

While these alternatives rely on different technologies to generate the wavefields, it may be possible to deploy them using the same vessels that deploy traditional sources. In particular, it is possible to deploy certain types of low-frequency sources using the same source vessels originally rigged/designed to tow classic source arrays, which generally deploy arrays of air-guns.

Without loss of generality, a source configuration can be realized by an industry operator using existing technologies on existing source vessels. In this example, a vessel can deploy up to 7 sub-arrays, and this is typically used to generate either, 2 sources of 3 sub-arrays each or 3 sources of 2 sub-arrays each. As the low-frequency source available to this particular operator can be deployed as if it was a sub-array of air-guns (using the same mechanical resources needed to deploy a sub-arrays of guns), this operator can deploy a low-frequency source on top of 2 or 3 traditional air-gun arrays.

In certain embodiment, this configuration may be expanded and other configurations also utilized such that different seismic source technologies are deployed by the same vessel at once, considering hardware (harness, towing, compressor, air pressure) and software (gun controller) specifications.

### Introduction to Well Placement and Evaluation

Well placement and real time evaluation of high angle and horizontal wells is a workflow that may be used to ensure a consistent distance to the caprock and delineate sub-layers within the reservoir. Contrasts in deep resistivity measurements are interpreted as changes in hydrocarbon saturation or formation composition. Wellbore images show layer boundaries and fractures which intersect the wellbore and texture variations representing the rock fabric. Sonic imaging in the same environment provides information about contrasts in acoustic impedance associated with structural features such as structural and stratigraphic boundaries, and the presence of natural fractures and faults.

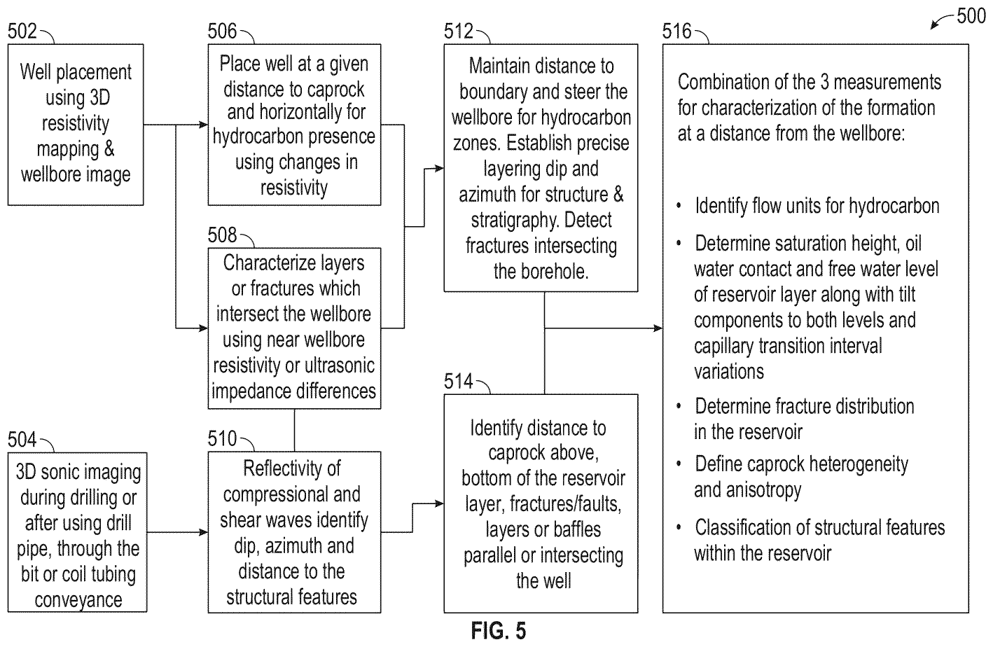

The integration of 3D resistivity mapping results, presented as 2D transverse resistivity inversions and 3D resistivity volumes, with 3D sonic imaging, presented as dip, azimuth, and distance to the reflector, provide an approach that can be used to gain information about the reservoir. However, when interpreting 3D resistivity mapping results from an ultra-deep azimuthal resistivity (UDAR) tool, one of the main challenges involves understanding and correlating the resistivity changes to formation boundaries or fluids changes within the volume of rock investigated. The 3D sonic imaging provides reflections caused by lithological or stratigraphic boundaries, and open natural fractures which may or may not intersect the borehole. By using the borehole images as a geological ground truth at the wellbore, the classification of the resistivity or acoustic contrasts can be done jointly to provide a consistent interpretation. FIG. 5 illustrates a workflow 500 for evaluating a wellbore based on 3D resistivity mapping, borehole images, and 3D sonic imaging, according to certain embodiments.

As illustrated in the workflow 500, at block 502, a well placement is determined using 3D resistivity mapping and wellbore image(s). At block 506, a well is placed at a given distance to caprock and horizontally for hydrocarbon presence using changes in resistivity, based on the well placement. Additionally, at block 508, one or more layers and/or fractures that intersect the wellbore are characterized using near wellbore resistivity or ultrasonic impedance differences. At block 504, 3D sonic imaging is performed during drilling or after drilling using a drill pipe, through the bit, or coil tubing conveyance. At block 510, using the layer/fracture information from block 508 and the 3D sonic imaging from block 504, the reflectivity of compressional and shear waves can identify dip, azimuth, and distance to the structural features.

At block 512, the distance to the boundary is maintained and the wellbore is steered for hydrocarbon zones. A precise layering dip and azimuth for structure and stratigraphy are established, and fractures interesting the borehole are detected. At block 514, the distance to the caprock above, bottom of the reservoir layer, fractures/faults, layers or baffles parallel or intersecting the well are determined. At block 516, the workflow 500 may use a combination of the three (3) measurements for characterization of the formation at a distance from the wellbore. Such a characterization may include (i) identifying flow units for hydrocarbon, determining saturation height, oil water connect and free water level of the reservoir layer along with tilt components to both levels and capillary transition interval variations, (ii) determining fracture distribution in the reservoir, (iii) defining caprock heterogeneity and anisotropy, (iv) classification of structural features within the reservoir, or (v) any combination thereof.

### Example Common Risk Segments, Fracture Ranking, and Texture Similarity for Completion Decisions

As noted, well completions represent a critical stage in the lifecycle of a well, where the objective is twofold: (i) to isolate wellbore intervals prone to water breakthrough and (ii) to optimize hydrocarbon recovery from targeted reservoir zones. However, as also noted, conventional approaches to well evaluation and completion planning rely on manual integration of data from diverse sources, including borehole images, deep resistivity measurements, sonic imaging, and seismic interpretation. This manual process involves collaboration among multiple subject matter experts and is time consuming, error prone, and difficult to scale. Additionally, using a manual process can make the visualization and interpretation of 3D measurement data significantly challenging and lead to delayed completion decisions as well as suboptimal outcomes due to incomplete analysis.

To address this, certain embodiments described herein provide techniques for well completion planning and design in subsurface hydrocarbon reservoirs. As described herein, a system can integrate measurements from multiple heterogeneous sources, including borehole images, 3D sonic imaging, 3D resistivity mapping, and seismic tools to determine pathways between fractures intersecting the wellbore and fractures away from the wellbore, identify pathways for water entry points, determine common risks associated with different intervals, isolate zones in communication with confirmed water contacts, assess risk tolerance and threshold sensitivity, select optimal completion design based on reservoir simulation, or any combination thereof.

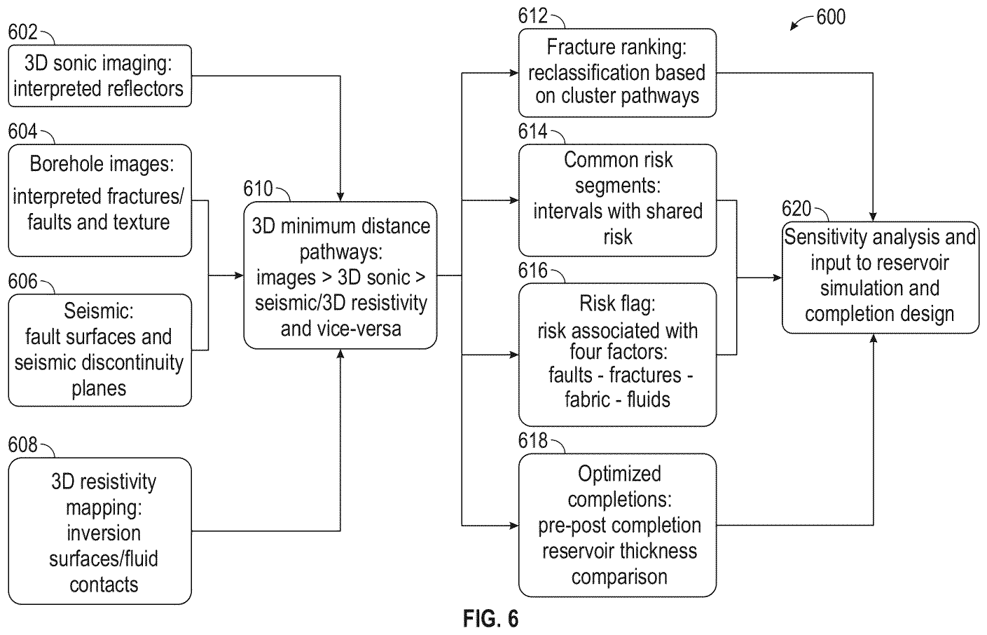

FIG. 6 illustrates a workflow 600 for well completion, according to certain embodiments. The workflow 600 may be implemented by a computing system, such as computing system 100 and/or or more components thereof. The workflow 600 integrates the measurements from borehole images, 3D sonic imaging, 3D resistivity mapping, and seismic tools to determine risks associated with water producing intervals to consider for completions and reservoir modelling. For example, the workflow 600 can determine the pathways along which fluids can flow into the wellbore and identify internals that should be isolated to avoid (or at least reduce) the risk of unwanted water production, while maximizing (or at least increasing) the thickness of low-risk intervals for hydrocarbon production. As shown, at block 610, the workflow 600 involves computing 3D distances and connectivity between features, based on the information/data in block 602 (e.g., 3D sonic imaging), block 604 (e.g., borehole images), block 606 (e.g., seismic information), and block 608 (e.g., 3D resistivity mapping). The 3D sonic imaging may include information, such as dip, azimuth, and distance to the acoustic reflector. The borehole images may include information regarding fractures/faults as well as texture of the fractures/faults. The seismic information may indicate fault surfaces and seismic discontinuity planes. The 3D resistivity mapping may include (or otherwise indicate) inversion surfaces and fluid contacts.

Consolidating the heterogeneous measurements into a completion decision may involve fracture ranking (block 612), determining common risk segments (block 614), classifying risks (block 616), and optimizing completions (block 618). At block 620, a sensitivity analysis of the inputs is conducted and completions and reservoir modeling are performed, based on blocks 602, 604, 606, and/or 608. The completions and reservoir modeling may involve passing resultant outputs through a reservoir model to simulate various completion designs. In this manner, embodiments can ensure a thorough examination of the data, facilitating the selection of the most suitable completion strategy.

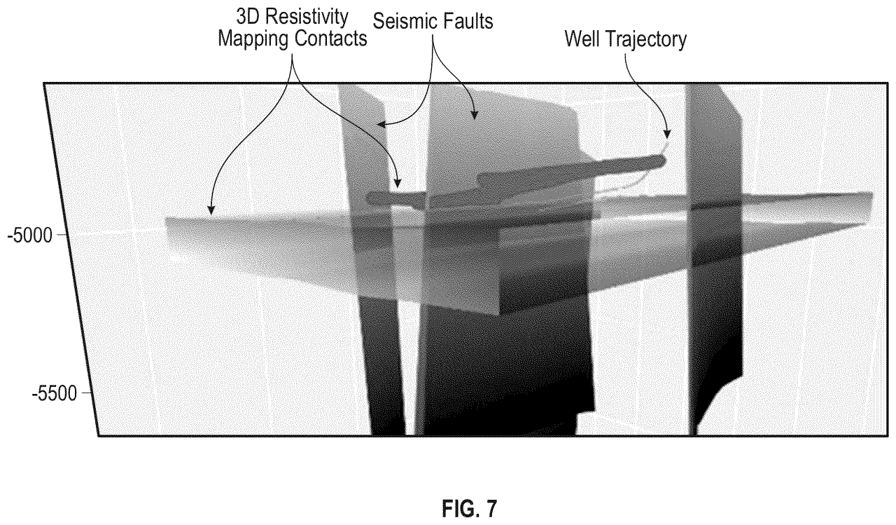

FIG. 7 illustrates a 3D view of a well trajectory plotted with seismic faults and resistivity mapping contacts (lithology or fluid), according to certain embodiments. In certain embodiments, computing the 3D distances (at block 610 of FIG. 6) may involve computing 3D distances between the surfaces representing faults, fractures, and fluid contacts. In certain cases, a minimum distance threshold may be used to determine whether surfaces can be considered intersecting or close enough to constitute a pathway along which fluids can migrate into the wellbore. The pathways are computed in two directions, either by starting at the wellbore and moving out to a known fluid contact, through fractures or faults, or by starting at the known fluid contact and computing pathways back to the wellbore.

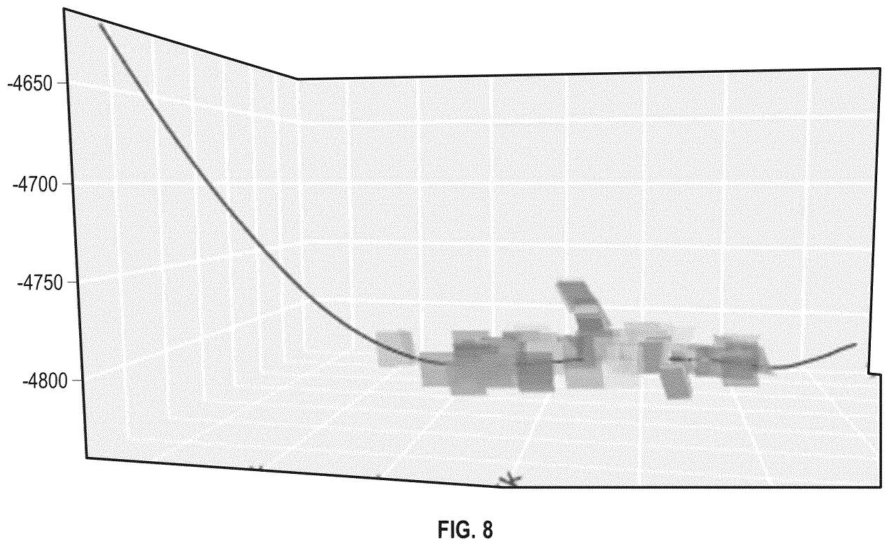

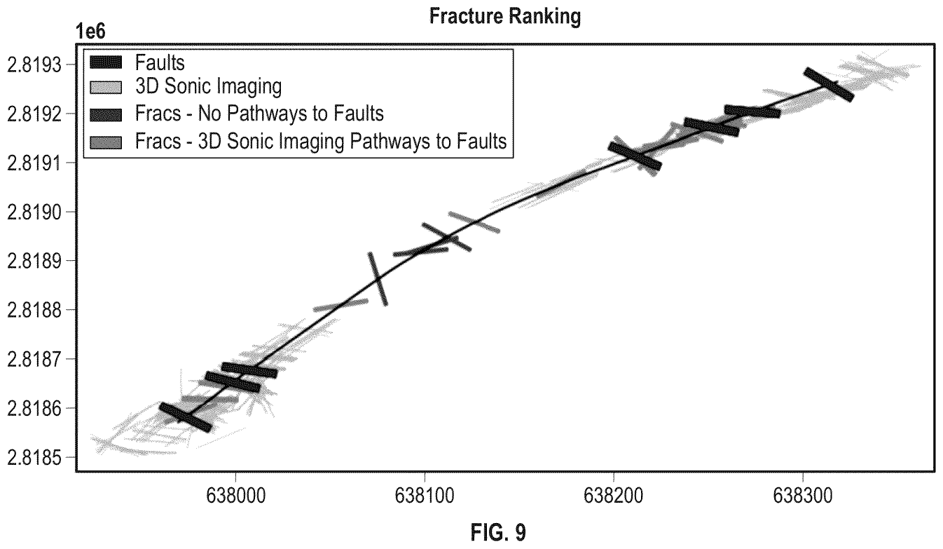

FIG. 8 illustrates another 3D view of a well trajectory plotted with 3D sonic imaging and borehole image fracture planes (color coded by azimuth), according to certain embodiments. At block 612 of FIG. 6, fractures from borehole images may be classified based on appearance, e.g. conductive or resistive for resistivity tools and open or closed for acoustic tools. However, determining whether those fractures are open or closed for fluid migration is less straightforward. Sonic imaging extends that classification to open or closed since it measures contrast with the surrounding rock fabric, increasing its sensitivity to open fractures. Since 3D sonic imaging measures fractures away from the borehole, it can be used to determine open fracture pathways. If these pathways are determined to intersect nearby faults or fluid contacts, a new classification scheme can be established, where borehole image fractures can be ranked based on the pathways they are connected to away from the wellbore. By way of example, FIG. 9 illustrates an example map view of a well trajectory plotted with 3D sonic imaging, borehole image fracture planes, and interpreted seismic faults (color coded by source and presence of confirmed pathways to known fluid contacts), according to certain embodiments.

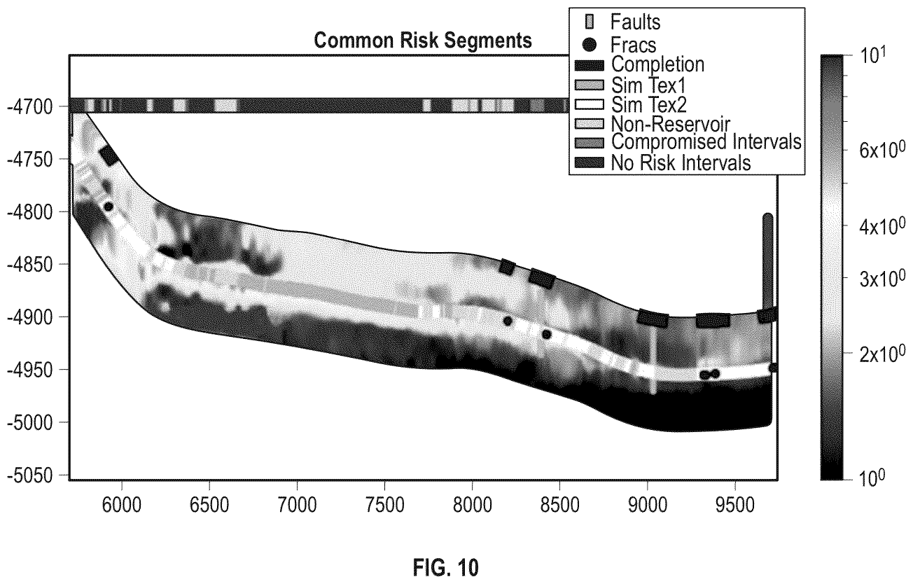

At block 614 of FIG. 6, the common risk segments may be determined by texture similarity. Fractures in the wellbore are discrete entry points for fluids, but completions are based on intervals where water entry is a risk. Therefore, an understanding of common risk segments in the wellbore can inform completion decisions. Since borehole images also provide information about rock fabric in the form of textures, the wellbore can be zoned based on similar textures which are expected to behave the same when it comes to fluid movement and displacement. These similar texture zones can be classified as reservoir or non-reservoir. By way of example, FIG. 10 illustrates a 2D cross-section (vertical sub-sea depth vs. measure depth in wellbore) showing 3D sensitivity mapping results (color bar scale), seismic faults, borehole image fractures and texture zonation, common risk segments (similar textures intersected by faults or fractures), and recommended intervals to isolate for completion, according to certain embodiments.

In certain embodiments, if fracture or faults intersect at any point along a continuous texture zone, then that entire zone may be designated at-risk (e.g., compromised interval) unless a completion is placed to isolate the fractures/faults. In certain embodiments, this visualization depicted in FIG. 10 may allow for quick inspection of common risk segments and the completion design tailored to isolate them.

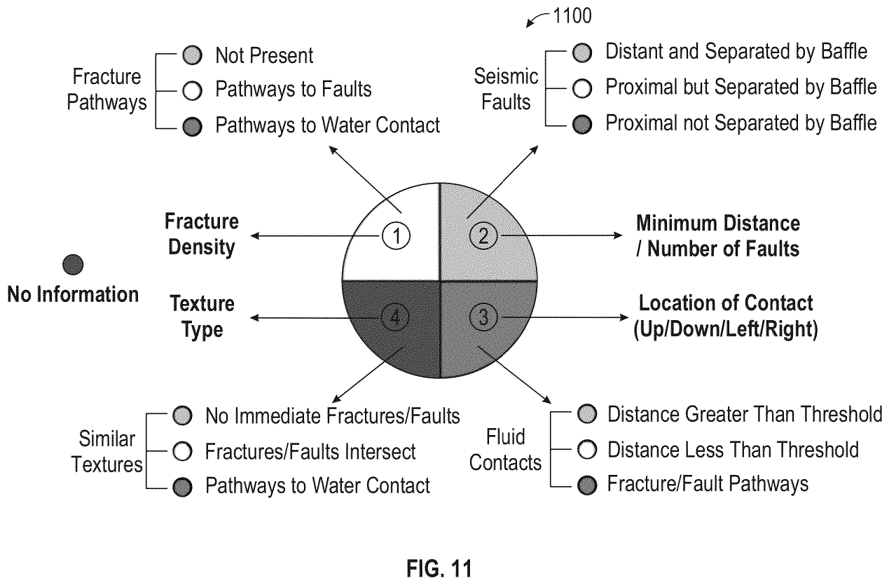

In certain cases, given the multiple heterogeneous sources of measurements, it may be desirable to provide an efficient technique for summarizing the results of multiple combinations of measurements. At block 616 of FIG. 6, for example, a risk flag color scheme is used to understand the associated risk of each source and its combination with the other sources. FIG. 11 illustrates an example risk flag scheme 1100, according to certain embodiments. In FIG. 11, each quadrant indicates information directly related to the measurement and a particular shade to define the risk associated with a particular interval along the wellbore.

Quadrant 1 includes information related to fracture density with different shades indicating a fracture pathway is not present, a pathway to a fault is present, or a pathway to a water contact is present. Quadrant 2 includes information related to minimum distance to fault/number of faults. Here, quadrant 2 may use different shades to indicate that a seismic fault is distant and separated by baffle, a seismic fault is proximal but separated by baffle, or a seismic fault is proximal and not separated by baffle. Quadrant 3 includes information related to the location of contact (up/down/left/right). Here, quadrant 3 may use different shades to indicate that the distance to a fluid contact is greater than a threshold, the distance to a fluid contact is less than a threshold, or there is a fracture/fault pathway. Quadrant 4 includes information related to texture type and uses different shades to indicate there are no immediate fractures/faults, there are fractures/faults intersecting, or there are pathways to a water contact. Note, for each quadrant, a certain shade (e.g., darkest shade) may be used to indicate that no information is available for that data type (e.g., fracture density, minimum distance/number of faults, texture type, location of contact, etc.) for a particular depth interval of the wellbore. Note that while FIG. 11 uses different shades to convey the level of risk associated with a particular interval along the wellbore, in other embodiments, the level of risk can be indicated using colors, highlighting, etc.

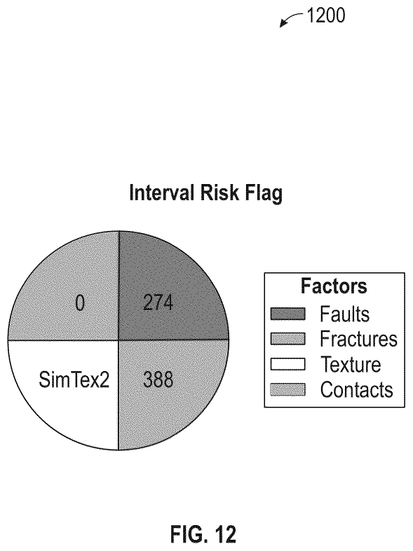

FIG. 12 illustrates an example risk flag 1200 for a selected interval along the wellbore, according to certain embodiments. The risk flag 1200 summarizes multiple risks associated with multiple heterogeneous measurements for a particular depth. Here, for example, the upper left quadrant (Quadrant 1) shows no fractures (0) and represents no risk. The upper right quadrant (Quadrant 2) shows a single fault, 274 feet (ft) away from the selected depth in the wellbore, not separated by a baffle/non-reservoir, which represents a high risk of being an entry point for water. The lower left quadrant (Quadrant 4) shows that the selected depth is within the SimTex2 texture zone (intermediate reservoir quality) and fractures of faults intersect somewhere along the zone, which represents a medium risk. The lower right quadrant (Quadrant 3) shows a water contact that is 388 ft away from the selected depth, which is greater than the distance threshold and represents a low risk.

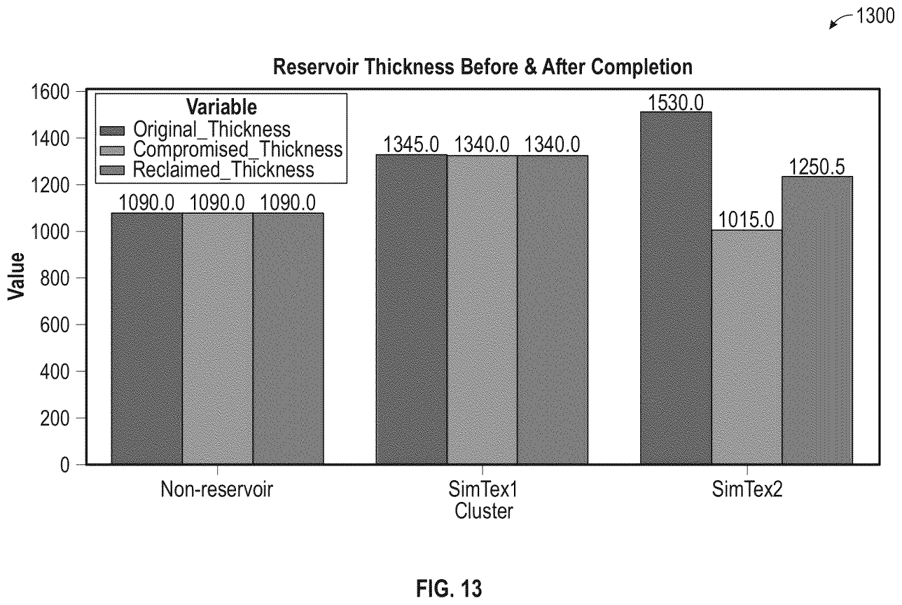

Referring back to FIG. 6, at block 618, the completion optimization may involve comparing the thicknesses of reservoir intervals before and after different completion designs to maximize (or at least increase) the hydrocarbon recovery while minimizing (or least reducing) water production from high risk intervals. By way of example, FIG. 13 illustrates a graph 1300 showing a comparison of reservoir thicknesses for each texture type before and after isolation of high risk intervals. As shown in FIG. 13, for each texture type (e.g., (e.g., non-reservoir, SimTex1 and SimTex2), the original cumulative thickness is shown, the thickness of the low risk intervals after subtracting the compromised intervals is shown, and the final thickness after isolating the high risk intervals is shown. In certain embodiments, the comparison illustrated in FIG. 13 can be performed for different completion designs based on the decisions taken after analyzing the fracture pathways, risk flags, and common risk segments.

Referring back to FIG. 6, at block 620, the sensitivity analysis and reservoir simulation that is performed may be based on two factors: (i) the calibration of thresholds utilized in computing minimum distances, and (ii) the assessment of risk tolerance associated with each measurement. This interplay allows for a comprehensive sensitivity analysis to be conducted, where the outcomes are integrated into reservoir modeling simulations. Through this iterative process, the dynamic interdependencies between completion parameters and reservoir dynamics are elucidated, culminating in the selection of an optimal completion design. This approach ensures the alignment of completion strategies with reservoir characteristics and enhances the overall efficacy of the production system.

### Example Operations

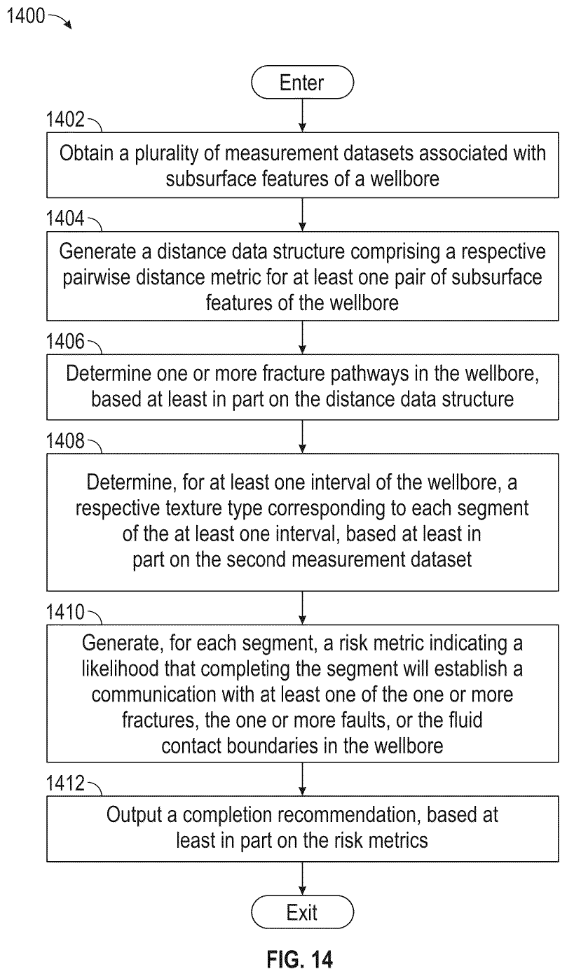

FIG. 14 is a flow diagram depicting an example operations 1400 for performing well completion and evaluation, according to certain embodiments. The operations 1400 may be performed, for example, by a computing system (e.g., computing system 100) or one or more components thereof.

The operations 1400 may involve, at block 1402, obtaining a plurality of measurement datasets associated with subsurface features of a wellbore. The plurality of measurement datasets include (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore.

The operations 1400 may also involve, at block 1404, generating a distance data structure comprising a respective pairwise distance metric for at least one pair of subsurface features of the wellbore.

The operations 1400 may also involve, at block 1406, determining one or more fracture pathways in the wellbore, based at least in part on the distance data structure.

The operations 1400 may also involve, at block 1408, determining, for at least one interval of the wellbore, a respective texture type corresponding to each segment of the at least one interval, based at least in part on the second measurement dataset.

The operations 1400 may also involve, at block 1410, generating, for each segment, a risk metric indicating a likelihood that completing the segment will establish a communication with at least one of the one or more fractures, the one or more faults, or the fluid contact boundaries in the wellbore.

The operations 1400 may further involve, at block 1412, outputting a completion recommendation, based at least in part on the risk metrics.

In certain embodiments, the risk metric is based on a plurality of risk flags, each risk flag being associated with a respective type of risk for establishing the communication.

In certain embodiments, the plurality of risk flags include (i) a first risk flag indicating a presence of one or more fracture pathways to at least one of the one or more faults or the one or more fluid contact boundaries, (ii) a second risk flag indicating at least one of a distance to the one or more faults or a number of the one or more faults, (iii) a third risk flag indicating a distance to the one or more fracture pathways, and (iv) a fourth risk flag indicating the texture type.

In certain embodiments, the at least one pair of subsurface features includes: a fault surface and a fracture surface; a fault surface and another fault surface; a fracture surface and another fracture surface; a fault surface and a fluid contact boundary; a fracture surface and a fluid contact boundary; or a combination thereof.

In certain embodiments, the operations 1400 further involves determining a respective ranking for each of the one or more fracture pathways, based at least in part on the first measurement dataset.

In certain embodiments, the first measurement dataset is obtained from sonic imaging of the wellbore.

In certain embodiments, the second measurement dataset is obtained from one or more images of the wellbore.

In certain embodiments, the third measurement dataset is obtained from resistivity mapping of the wellbore.

In certain embodiments, the fourth measurement dataset includes seismic information associated with the one or more fault surfaces in the wellbore.

In certain embodiments, the operations 1400 further involve: (i) generating, for each segment, a plurality of reservoir thicknesses for each respective distance along an analysis interval, the plurality of reservoir thicknesses comprising a first reservoir thickness prior to completion of the segment and a second reservoir thickness associated with post completion of the segment; and (ii) generating the completion recommendation based at least in part on the plurality of reservoir thicknesses.

### Example Clauses

Implementation examples are described in the following numbered clauses:

Clause 1: A computer-implemented method comprising: obtaining a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore; generating a distance data structure comprising a respective pairwise distance metric for at least one pair of subsurface features of the wellbore; determining one or more fracture pathways in the wellbore, based at least in part on the distance data structure; determining, for at least one interval of the wellbore, a respective texture type corresponding to each segment of at least one interval, based at least in part on the second measurement dataset; generating, for each segment, a risk metric indicating a likelihood that completing the segment will establish a communication with at least one of the one or more fractures, the one or more faults, or the fluid contact boundaries in the wellbore; and outputting a completion recommendation, based at least in part on the risk metrics.

Clause 2: The computer-implemented method of Clause 1, wherein the risk metric is based on a plurality of risk flags, each risk flag being associated with a respective type of risk for establishing the communication.

Clause 3: The computer-implemented method of Clause 2, wherein the plurality of risk flags comprises (i) a first risk flag indicating a presence of one or more fracture pathways to at least one of the one or more faults or the one or more fluid contact boundaries, (ii) a second risk flag indicating at least one of a distance to the one or more faults or a number of the one or more faults, (iii) a third risk flag indicating a distance to the one or more fracture pathways, and (iv) a fourth risk flag indicating the texture type.

Clause 4: The computer-implemented method in accordance with any of Clauses 1-3, wherein the at least one pair of subsurface features comprises: a fault surface and a fracture surface; a fault surface and another fault surface; a fracture surface and another fracture surface; a fault surface and a fluid contact boundary; a fracture surface and a fluid contact boundary; or a combination thereof.

Clause 5: The computer-implemented method in accordance with any of Clauses 1-4, further comprising determining a respective ranking for each of the one or more fracture pathways, based at least in part on the first measurement dataset.

Clause 6: The computer-implemented method in accordance with any of Clauses 1-5, wherein the first measurement dataset is obtained from sonic imaging of the wellbore.

Clause 7: The computer-implemented method in accordance with any of Clauses 1-6, wherein the second measurement dataset is obtained from one or more images of the wellbore.

Clause 8: The computer-implemented method in accordance with any of Clauses 1-7, wherein the third measurement dataset is obtained from resistivity mapping of the wellbore.

Clause 9: The computer-implemented method in accordance with any of Clauses 1-8, wherein the fourth measurement dataset comprises seismic information associated with the one or more fault surfaces.

Clause 10: The computer-implemented method in accordance with any of Clauses 1-9, further comprising: generating, for each segment, a plurality of reservoir thicknesses for each respective distance along an analysis interval, the plurality of reservoir thicknesses comprising a first reservoir thickness prior to completion of the segment and a second reservoir thickness associated with post completion of the segment; and generating the completion recommendation based at least in part on the plurality of reservoir thicknesses.

Clause 11: A computing system comprising: one or more memories collectively storing instructions; and one or more processors communicatively coupled to the one or more memories, the one or more processors being collectively configured to execute the instructions to cause the computing system to: obtain a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore; generate a distance data structure comprising a respective pairwise distance metric for at least one pair of subsurface features of the wellbore; determine one or more fracture pathways in the wellbore, based at least in part on the distance data structure; determine, for at least one interval of the wellbore, a respective texture type corresponding to each segment of the at least one interval, based at least in part on the second measurement dataset; generate, for each segment, a risk metric indicating a likelihood that completing the segment will establish a communication with at least one of the one or more fractures, the one or more faults, or the fluid contact boundaries in the wellbore; and output a completion recommendation, based at least in part on the risk metrics.

Clause 12: The computing system of Clause 11, wherein the risk metric is based on a plurality of risk flags, each risk flag being associated with a respective type of risk for establishing the communication.

Clause 13: The computing system of Clause 12, wherein the plurality of risk flags comprises (i) a first risk flag indicating a presence of one or more fracture pathways to at least one of the one or more faults or the one or more fluid contact boundaries, (ii) a second risk flag indicating at least one of a distance to the one or more faults or a number of the one or more faults, (iii) a third risk flag indicating a distance to the one or more fracture pathways, and (iv) a fourth risk flag indicating the texture type.

Clause 14: The computing system in accordance with any of Clauses 11-13, wherein the at least one pair of subsurface features comprises: a fault surface and a fracture surface; a fault surface and another fault surface; a fracture surface and another fracture surface; a fault surface and a fluid contact boundary; a fracture surface and a fluid contact boundary; or a combination thereof.

Clause 15: The computing system in accordance with any of Clauses 11-14, wherein the one or more processors are collectively configured to execute the instructions to cause the computing system to further determine a respective ranking for each of the one or more fracture pathways, based at least in part on the first measurement dataset.

Clause 16: The computing system in accordance with any of Clauses 11-15, wherein the first measurement dataset is obtained from sonic imaging of the wellbore.

Clause 17: The computing system in accordance with any of Clauses 11-16, wherein the second measurement dataset is obtained from one or more images of the wellbore.

Clause 18: The computing system in accordance with any of Clauses 11-17, wherein the third measurement dataset is obtained from resistivity mapping of the wellbore.

Clause 19: The computing system in accordance with any of Clauses 11-18, wherein the fourth measurement dataset comprises seismic information associated with the one or more fault surfaces.

Clause 20: A non-transitory computer-readable storage medium comprising computer executable code, which when executed by one or more processors of a computing system, perform an operation comprising: obtaining a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore; generating a distance data structure comprising a respective pairwise distance metric for at least one pair of subsurface features of the wellbore; determining one or more fracture pathways in the wellbore, based at least in part on the distance data structure; determining, for at least one interval of the wellbore, a respective texture type corresponding to each segment of the at least one interval, based at least in part on the second measurement dataset; generating, for each segment, a risk metric indicating a likelihood that completing the segment will establish a communication with at least one of the one or more fractures, the one or more faults, or the fluid contact boundaries in the wellbore; and outputting a completion recommendation, based at least in part on the risk metrics.

Clause 21: A non-transitory computer-readable storage medium comprising computer-executable code, which when executed by one or more processors of a computing system, perform a method in accordance with any of Clauses 1-10.

Clause 22: An apparatus comprising means for performing a method in accordance with any of Clauses 1-10.

Clause 23: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a FPGA or other PLD, discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method comprising:
obtaining a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore;
generating a distance data structure comprising a respective pairwise distance metric for at least one pair of subsurface features of the wellbore;
determining one or more fracture pathways in the wellbore, based at least in part on the distance data structure;
determining, for at least one interval of the wellbore, a respective texture type corresponding to each segment of at least one interval, based at least in part on the second measurement dataset;
generating, for each segment, a risk metric indicating a likelihood that completing the segment will establish a communication with at least one of the one or more fractures, the one or more faults, or the fluid contact boundaries in the wellbore; and
outputting a completion recommendation, based at least in part on the risk metrics.

2. The computer-implemented method of claim 1, wherein the risk metric is based on a plurality of risk flags, each risk flag being associated with a respective type of risk for establishing the communication.

3. The computer-implemented method of claim 2, wherein the plurality of risk flags comprises (i) a first risk flag indicating a presence of one or more fracture pathways to at least one of the one or more faults or the one or more fluid contact boundaries, (ii) a second risk flag indicating at least one of a distance to the one or more faults or a number of the one or more faults, (iii) a third risk flag indicating a distance to the one or more fracture pathways, and (iv) a fourth risk flag indicating the texture type.

4. The computer-implemented method of claim 1, wherein the at least one pair of subsurface features comprises:
a fault surface and a fracture surface;
a fault surface and another fault surface;
a fracture surface and another fracture surface;
a fault surface and a fluid contact boundary;
a fracture surface and a fluid contact boundary; or
a combination thereof.

5. The computer-implemented method of claim 1, further comprising determining a respective ranking for each of the one or more fracture pathways, based at least in part on the first measurement dataset.

6. The computer-implemented method of claim 1, wherein the first measurement dataset is obtained from sonic imaging of the wellbore.

7. The computer-implemented method of claim 1, wherein the second measurement dataset is obtained from one or more images of the wellbore.

8. The computer-implemented method of claim 1, wherein the third measurement dataset is obtained from resistivity mapping of the wellbore.

9. The computer-implemented method of claim 1, wherein the fourth measurement dataset comprises seismic information associated with the one or more fault surfaces.

10. The computer-implemented method of claim 1, further comprising:
generating, for each segment, a plurality of reservoir thicknesses for each respective distance along an analysis interval, the plurality of reservoir thicknesses comprising a first reservoir thickness prior to completion of the segment and a second reservoir thickness associated with post completion of the segment; and
generating the completion recommendation based at least in part on the plurality of reservoir thicknesses.

11. A computing system comprising:
one or more memories collectively storing instructions; and
one or more processors communicatively coupled to the one or more memories, the one or more processors being collectively configured to execute the instructions to cause the computing system to:
obtain a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore;
generate a distance data structure comprising a respective pairwise distance metric for at least one pair of subsurface features of the wellbore;
determine one or more fracture pathways in the wellbore, based at least in part on the distance data structure;
determine, for at least one interval of the wellbore, a respective texture type corresponding to each segment of the at least one interval, based at least in part on the second measurement dataset;
generate, for each segment, a risk metric indicating a likelihood that completing the segment will establish a communication with at least one of the one or more fractures, the one or more faults, or the fluid contact boundaries in the wellbore; and
output a completion recommendation, based at least in part on the risk metrics.

12. The computing system of claim 11, wherein the risk metric is based on a plurality of risk flags, each risk flag being associated with a respective type of risk for establishing the communication.

13. The computing system of claim 12, wherein the plurality of risk flags comprises (i) a first risk flag indicating a presence of one or more fracture pathways to at least one of the one or more faults or the one or more fluid contact boundaries, (ii) a second risk flag indicating at least one of a distance to the one or more faults or a number of the one or more faults, (iii) a third risk flag indicating a distance to the one or more fracture pathways, and (iv) a fourth risk flag indicating the texture type.

14. The computing system of claim 11, wherein the at least one pair of subsurface features comprises:
a fault surface and a fracture surface;
a fault surface and another fault surface;
a fracture surface and another fracture surface;
a fault surface and a fluid contact boundary;
a fracture surface and a fluid contact boundary; or
a combination thereof.

15. The computing system of claim 11, wherein the one or more processors are collectively configured to execute the instructions to cause the computing system to further determine a respective ranking for each of the one or more fracture pathways, based at least in part on the first measurement dataset.

16. The computing system of claim 11, wherein the first measurement dataset is obtained from sonic imaging of the wellbore.

17. The computing system of claim 11, wherein the second measurement dataset is obtained from one or more images of the wellbore.

18. The computing system of claim 11, wherein the third measurement dataset is obtained from resistivity mapping of the wellbore.

19. The computing system of claim 11, wherein the fourth measurement dataset comprises seismic information associated with the one or more fault surfaces.

20. A non-transitory computer-readable storage medium comprising computer executable code, which when executed by one or more processors of a computing system, perform an operation comprising:
obtaining a plurality of measurement datasets associated with subsurface features of a wellbore, wherein the plurality of measurement datasets comprises (i) a first measurement dataset indicating one or more reflectors in the wellbore, (ii) a second measurement dataset indicating at least one of one or more fractures or one or more faults in the wellbore, (iii) a third measurement dataset indicating at least one of one or more inversion surfaces or fluid contact boundaries in the wellbore, and (iv) a fourth measurement dataset indicating one or more fault surfaces in the wellbore;
generating a distance data structure comprising a respective pairwise distance metric for at least one pair of subsurface features of the wellbore;
determining one or more fracture pathways in the wellbore, based at least in part on the distance data structure;
determining, for at least one interval of the wellbore, a respective texture type corresponding to each segment of the at least one interval, based at least in part on the second measurement dataset;
generating, for each segment, a risk metric indicating a likelihood that completing the segment will establish a communication with at least one of the one or more fractures, the one or more faults, or the fluid contact boundaries in the wellbore; and
outputting a completion recommendation, based at least in part on the risk metrics.
